(19) United States
(12) Patent Application Publication
(10) Pub. No.: US 2021/0304311 A1
(43) Pub. Date: Sep. 30, 2021

(54) APPARATUS AND METHOD FOR ASSURING PERFORMANCE ATTRIBUTES OF A DIGITAL ASSET

(71) Applicant: QUANTSTAMP, INC, San Francisco, CA (US)

(72) Inventors: Sebastian BANESCU, Punchheim (DE); Jan Joseph Bogacki GORZNY, Toronto (CA); Richard MA, Toronto (CA); Steven STEWART, Fredicton (CA)

(21) Appl. No.: 17/343,610

(22) Filed: Jun. 9, 2021

Related U.S. Application Data
(63) Continuation-in-part of application No. 16/262,515, filed on Jan. 30, 2019, now abandoned.
(60) Provisional application No. 62/685,135, filed on Jun. 14, 2018.

(51) Int. Cl. G06Q 40/06; G06Q 10/10; G06Q 20/06; G06Q 20/40; G06Q 40/08; H04L 29/06

(52) U.S. Cl. CPC G06Q 40/06; G06Q 10/10; G06Q 20/0655; G06Q 40/02; G06Q 40/08; H04L 63/1433; G06Q 20/4016

(57) ABSTRACT

A computer implemented method includes maintaining at a first network connected server a record of a group of stakeholders with an interest in the performance attributes of a digital asset. Maintaining includes collecting stakeholder digital consideration from the group of stakeholders. A second network connected server stores a list of experts on the performance attributes of digital assets. A first endorsement of the performance attributes of a digital asset and expert digital consideration are received at the first network connected server from a network connected expert client machine. A second endorsement of the performance attributes of the digital asset and non-expert digital consideration are received at the first network connected server from a network connected non-expert client machine. The first network connected server periodically distributes stakeholder digital consideration increments of the stakeholder digital consideration to the network connected expert client machine and the network connected non-expert client machine. The expert digital consideration and the non-expert digital consideration are distributed to the stakeholders in the event that the endorsements of the performance attributes of the digital asset do not match defined criteria. Distributing is initiated by the first network connected server utilizing the network to distribute to network connected stakeholder client machines. The defined criteria is collected from network connected sensor machines periodically communicating to the first network connected server suspicious bit patterns that are evaluated by the first network connected server to periodically issue a warning when the suspicious bit patterns exceed a threshold associated with the expert digital consideration.

### CROSS-REFERENCE TO RELATED APPLICATION

This application is a continuation-in-part of U.S. Ser. No. 16/262,515, filed Jan. 30, 2019, which claims priority to U.S. Provisional Patent Application Ser. No. 62/685,135, filed Jun. 14, 2018, the contents of each application are incorporated herein by reference.

### FIELD OF THE INVENTION

This invention relates generally to communications in computer networks. More particularly, this invention is directed to assuring performance attributes of a digital asset.

### BACKGROUND OF THE INVENTION

Digital assets are manifested in a variety of forms, such as executable code and a computerized transaction structure that executes the terms of a contract, sometimes referred to as a smart contract. The performance attributes of a digital asset are of great concern to the publisher of the digital asset and various third-parties that may have an interest in the digital asset. It is known to use experts for manual audits and code inspections. Unfortunately, this prior art approach is not scalable and is completely centralized.

Thus, there is a need to develop scalable and decentralized techniques to assure the performance attributes of a digital asset.

### SUMMARY OF THE INVENTION

A computer implemented method includes maintaining at a first network connected server a record of a group of stakeholders with an interest in the performance attributes of a digital asset. Maintaining includes collecting stakeholder digital consideration from the group of stakeholders. A second network connected server stores a list of experts on the performance attributes of digital assets. A first endorsement of the performance attributes of a digital asset and expert digital consideration are received at the first network connected server from a network connected expert client machine. A second endorsement of the performance attributes of the digital asset and non-expert digital consideration are received at the first network connected server from a network connected non-expert client machine.

The first network connected server periodically distributes stakeholder digital consideration increments of the stakeholder digital consideration to the network connected expert client machine and the network connected non-expert client machine. The expert digital consideration and the non-expert digital consideration are distributed to the stakeholders in the event that the endorsements of the performance attributes of the digital asset do not match defined criteria. Distributing is initiated by the first network connected server utilizing the network to distribute to network connected stakeholder client machines. The defined criteria is collected from network connected sensor machines periodically communicating to the first network connected server suspicious bit patterns that are evaluated by the first network connected server to periodically issue a warning when the suspicious bit patterns exceed a threshold associated with the expert digital consideration.

### BRIEF DESCRIPTION OF THE FIGURES

The invention is more fully appreciated in connection with the following detailed description taken in conjunction with the accompanying drawings, in which:

FIG. 1 illustrates a system configured in accordance with an embodiment of the invention.

FIG. 2 illustrates a protocol violation associated with an embodiment of the invention.

FIG. 3 illustrates successful execution of a protocol associated with an embodiment of the invention.

FIG. 4 illustrates a protocol violation associated with an embodiment of the invention.

FIG. 5 illustrates a matrix for a protocol without a minimum stake requirement.

FIG. 6 illustrates another system configured in accordance with an embodiment of the invention.

FIG. 7 illustrates sensor logic module processing performed in accordance with an embodiment of the invention.

FIG. 8 illustrates sensor logic module processing performed in accordance with another embodiment of the invention.

FIG. 9 illustrates sensor logic module processing performed in accordance with another embodiment of the invention.

Like reference numerals refer to corresponding parts throughout the several views of the drawings.

### DETAILED DESCRIPTION OF THE INVENTION

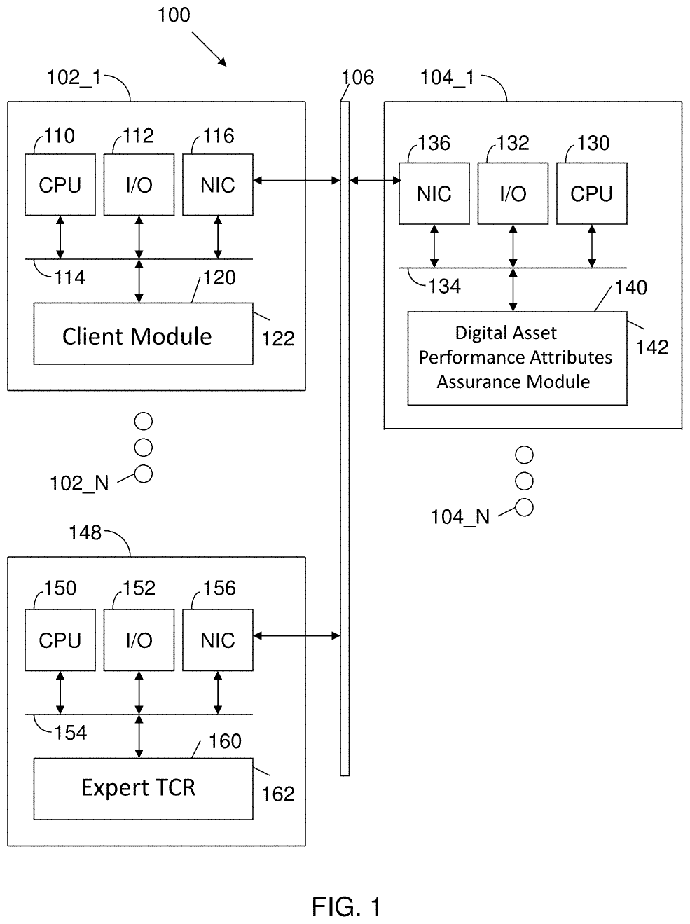

FIG. 1 illustrates a system 100 configured in accordance with an embodiment of the invention. The system includes a set of client devices 102_1 through 102_N in communication with servers 104_1 through 104_N via network 106. Network 106 may be any combination of wired and wireless networks.

Each client device 102 (e.g., 102_1) may be a computer, tablet, smart phone and the like. A processor (e.g. central processing unit) 110 is connected to input/output devices 112 via a bus 114. The input/output devices 112 may include a keyboard, mouse, touch display and the like. A network interface circuit 116 is also connected to the bus 114 to provide connectivity to network 106. A memory 120 is also connected to the bus 114. The memory 120 stores instructions (e.g., client module 122) executed by the processor 110 to implement client side operations disclosed herein. The client machines 102 may be associated with experts and non-experts, terms that are described below. As such, they may be referred to as a network connected expert client machine or a network connected non-expert client machine. The client machines 102 may also be associated with stakeholders, as described below. As such, they may be referred to as stakeholder client machines.

Each server 104 (e.g., 104_1) includes a processor 130, input/output devices 132, bus 134 and a network interface circuit 136. A memory 140 is connected to bus 134. The memory stores a digital asset performance attributes assurance module 142, which includes instructions executed by processor 130 to implement operations disclosed herein. In particular, the module 142 is part of a distributed computer system that implements the operations of maintaining a record of a group of stakeholders with an interest in the performance attributes of a digital asset. The performance attributes are machine interpretable requirements, such as security measures.

Maintaining a record of a group of stakeholders includes collecting stakeholder digital consideration from the group of stakeholders. A second network connected server 148 stores a list of experts on the performance attributes of digital assets. A first endorsement of the performance attributes of a digital asset and expert digital consideration are received by module 142 from a network connected expert client machine. A second endorsement of the performance attributes of the digital asset and non-expert digital consideration are received at module 142 from a network connected non-expert client machine. The module 142 periodically distributes stakeholder digital consideration increments of the stakeholder digital consideration to the network connected expert client machine and the network connected non-expert client machine. The expert digital consideration and the non-expert digital consideration are distributed to the stakeholders in the event that the endorsements of the performance attributes of the digital asset do not match defined criteria.

Server 148 includes a processor 150, input/output devices 152, a bus 154 and a network interface circuit 156. A memory 160 is also connected to the bus 154. The memory 160 stores instructions executed by processor 150 to implement an expert Token Curated Registry (TCR) 162, the details of which are discussed below.

A precise notion of expertise is hard to define, but expertise is often determined by experience and reputation. Typically an expert is a professional security auditor, whereas a non-expert is someone who may be familiar with security concerns but is untrusted, unknown, inexperienced, or simply a speculator. According to this definition, non-experts may still be able to contribute to digital asset security in the right setting.

Additionally, in a decentralized ecosystem, there may be users other than the digital asset owner who are willing to pay for the financial protection of the digital asset. These participants, along with the digital asset owner, are referred to as stakeholders. There is no need to prohibit these actors from participating in the security of the digital asset. For example, a shareholder in a company that sells computer programs may have an interest in assuring that published computer programs are bug free to avoid damage to company reputation and share price. In the case of a smart contract, any number of entities may have an interest in the performance of that digital asset.

The disclosed protocol enables a form of security that is complementary to the traditional security provided by code inspections, testing, and formal methods. Moreover, the protocol decreases the need for security experts as well-funded non-experts may suffice to assure digital asset performance attributes, such as security vulnerabilities. The protocol develops security expertise by enabling non-experts to observe and possibly determine an expert's motivation for staking (or not-staking) contracts. It also enables and incentivizes both experts and non-experts to participate in the digital asset ecosystem.

In accordance with the protocol, anyone can claim that a digital asset is correct by staking digital consideration, such as a digital currency, a digital resource (e.g., memory, processor cycles), etc. Such digital consideration is called a stake. Each stakeholder wishes to have a minimum amount staked as digital consideration. Each stake is associated with one stakeholder. In the event that a digital asset does not match defined criteria, each stakeholder can claim digital consideration of the users who assured the performance of the digital asset. In exchange for their stake, these users regularly receive digital consideration as long as the digital asset meets performance attributes. The performance attributes of executable code may be a scaling attribute, a security attribute and the like. The performance attribute of a smart contract may be that its balance is correct. The stakes, and a deposit of fees to be paid by the stakeholders to the stakers, are held in escrow in accordance with the protocol.

In one embodiment, expert stakers earn a higher return than non-expert stakers. In a very broad sense, this is “Proof-of-Stake” for digital asset correctness: instead of staking that a block is correct, participants stake that a digital asset is secure.

From the point of view of a stakeholder, this protocol is roughly analogous to insurance. In this analogy, the stakers are underwriters of the contract security. However, this analogy is not perfect: in this model, there is no actuary model which underwriters (stakers) are following. Moreover, stakers are free to stake as much or as little as they wish, based on their opinion of the digital asset, or the stakes of more expert stakers. Furthermore, in this setting, the protocol leverages the automated evaluation of digital, contrary to the manual claim approval of traditional insurance agencies. Users may wish to develop their own actuary models, but this is not expected or required. Lastly, stakeholders are free to set the conditions of the policy, which is often not the case in centralized insurance settings.

A stakeholder may request collateral which exceeds the value of the digital asset to which the stakeholder has an interest. This is acceptable provided that they are paying sufficiently high fees, the market will dictate whether or not stakers find the risk acceptable. If the digital asset is seen as secure, the collateral will never be forfeited by the stakers, and there is no reason to limit the size of funds they wish to stake. The size of the stakes on a digital asset may indicate the community's confidence in the security of the digital asset. In the event that an insecure digital asset misbehaves, the stakeholder claims the entirety of their stakes, even if that is worth more than the funds that were compromised. Stakers may wish to take care not to stake more than is appropriate, in order to prevent hard-to-find back-doors in the digital asset to be exploited, resulting in a large profit for the stakeholder, or to do their due diligence in checking the security of the digital asset in the first place. The stakeholder may also submit a policy that they can change over time, and in this case it is the responsibility of the staker to ensure that those possible changes introduce an acceptable level of risk.

From the point of view of a staker, this protocol is roughly analogous to banking. A staker deposits a sum (their collateral) into the protocol contract, and earns a portion of fees paid by the contract stakeholder. The protocol is not exactly the same as a bank account: the amount earned is not a fixed percentage, and is relative to the size of a staker's contribution to the total funds staked (i.e., the total size of funds held by the bank in the analogy), and there is no guarantee that the funds are safe. In particular, the staker can view the protocol as a bank whose security they are free to assess, and store funds only if they deem the bank is secure. If the funds are lost because the protocol deems that the relevant digital asset misbehaves, there is no way to recover the staker's funds: it will automatically be transferred to the stakeholder.

The protocol is referred to as the QSPb protocol. QSPb encourages further adoption of digital assets by providing an additional level of economic security. As people are willing to pay for insurance, it is believed that people will pay to secure their digital assets. Participants in the QSPb protocol can be of two types: stakeholders (who include the digital asset owner, if in existance), and stakers. Recall that stakeholders are participants who are willing to pay to ensure the contract's funds are not stolen. Stakers are participants with funds available who are willing to stake collateral against the security of a smart contract; they can be experts or non-experts. A list of experts may be maintained via a Token Curated Registry. A TCR is used to vote in community members as security experts. Anyone not on the TCR is a non-expert.

In one embodiment, the protocol is designed to be implemented in a smart contract which accepts the addresses of other smart contracts. Suppose that a smart contract Contract with owner Owner is submitted to QSPb. The address of Contract may be submitted by Owner, who is seeking financial assurance that their contract's funds are secure, or by another stakeholder. In fact, there is no distinction between the contract owner and another arbitrary stakeholder. Whoever submits the address of Contract to QSPb outlines (formally) a set of rules indicating their definition of misbehavior, e.g., the balance of Contract is withdrawn by an address which is not specified somewhere in the contract. Stakers, who may include non-experts, contribute to pools of funds that are available to the stakeholder if the protocol detects that the Contract has misbehaved. While the protocol deems the submitted contract is secure, stakers are periodically paid by the stakeholder who initialized the pool to which the stakers have contributed. The funds in the staked pool are sent to the stakeholder if the protocol detects misbehavior. The QSPb smart contract can automatically rule if the contract misbehaved. QSPb will check this at the time the protocol checks if a periodic payment is due to take place. Additional pools of funds may be collected for each stakeholder who is willing to pay stakers.

Each stakeholder, along with the digital asset owner indicates a separate minimum amount of assurance required for their pool. For example, suppose that a digital asset Wallet is expected to hold 20,000 QSP digital currency, which may be accessible by many users. A stakeholder Alice may determine that she wishes to be compensated with 30,000 QSP in the event that these funds are stolen, as she thinks it will be costly to transition to a new smart contract if her funds in Wallet are lost. On the other hand, a stakeholder Bob may only have 3,000 QSP in the Wallet, and therefore only request a pool worth at least 3,000 QSP. It is expected that Bob will pay a smaller rate compared to Alice. If no stakers stake in either pool, it may be the case that Wallet is not secure; it may just be that neither Alice nor Bob are paying a high enough fee to warrant the risk of staking funds for this contract. Neither Alice nor Bob will pay any fees (or be eligible for any staked collateral) until their respective pool has at least the minimum amount of requested QSP in it.

In exchange for their stake, stakers are periodically paid. To continue the example above, if Alice wishes to have a payout of 30,000 QSP in the event the Wallet is hacked, she may pay 300 QSP every p blocks. This 300 QSP will be split amongst the stakers once at least 30,000 QSP is staked for Alice. Each staker is paid a portion of the 300 QSP proportional to the proportion of the (at least) 30,000 QSP which is staked, subject to bonuses if they are an expert, or the first expert, to stake. This system favors the stakeholders, as stakeholders are guaranteed a minimum payout if enough collateral is available, whereas stakers are not guaranteed a minimum payout amount, even if the minimum amount of staked collateral is sufficiently high.

The protocol allows non-experts, who either genuinely believe the contract to be secure, or are merely guessing that it is, to stake funds. The protocol does not assign or calculate odds, and bets are not placed (and fixed). If participants are assumed to be rational actors, then collateral will only be placed on secure contracts with fixed policies. QSPb does not require wealthy individuals to stake collateral. Many small stakers can make up the staking pool.

The protocol is complementary to the idea that digital assets can be automatically verified. Automatic verification is not able to capture all aspects of digital asset execution—if this was the case, manual audits would never be necessary. Many automated tools require additional formal specifications from digital asset writers, and therefore put an additional burden on digital asset writers, who may not be experts in these tools or their languages. Automatic verification often results in false positives, which require manual review in order to determine if they are true positives.

The successful adoption of this protocol slows the velocity of the digital currency staked. The velocity of the currency refers to how fast the currency “passes from one holder to the next”. Informally, a token's velocity is inversely proportional to the value of the token; often-traded, rarely-kept tokens are therefore worth less than those which are held for longer. A token's velocity affects its future value. The QSPb protocol slows the velocity of the tokens used as collateral as it temporarily locks up these funds. QSPb does not affect the total supply: staked tokens are either returned or paid out; never destroyed. Moreover, the use of a TCR enables further token utility as it is required for interactions governing this list. A requirement that submitted digital assets are also subjected to an automated security check (e.g., through a computer network) also increases the utility of the security network token (i.e., QSP). As there may be false positives in such a report, the report will be published so that stakers can determine for themselves if the concerns are warranted. This requirement helps to prevent digital assets with obvious back-doors being submitted, increasing the trust of the network by reducing possible cases of malicious behavior.

In one embodiment, QSPb is deployed on the blockchain and may be open sourced; therefore it may be possible to clone the protocol. Strong network effects will make the successful deployment of this protocol useful for new digital asset developers and increase the difficulty of copying the protocol.

QSPb does not guarantee the absence of issues in the contracts that are submitted to it. There is a risk involved in staking funds and stakers must take care to ensure that they are comfortable with this risk, and digital asset owners believe that the cost is worthwhile.

The protocol, developed in full generality, may not need to restrict the definition of an attack to the simple one assumed above. A definition of an attack, or unintended behavior of a digital asset may be defined and published by the stakeholder. This definition could be in some standard, machine verifiable language, or simply in plain language that allows a panel of (human) judges to determine if the attack has occurred. This may mean that an attack may not conform to a standard, “moral” definition of an attack: a rule may say that if the owner withdraws all funds, that is undesirable—even though this may not be seen to be an attack by others. Provided the rules are published externally to the stakers, it is up to them to determine if they wish to fund the staking pool.

The disclosed protocol resolves the problem of scalable verification. This protocol provides a solution by providing a marketplace that will allow anyone to stake collateral. If participants are rational, such collateral is validation that an audit process has taken place and no errors are found. Thus, QSPb is a complementary protocol to automated mechanical checks which can scale with the market while mitigating the risk of false positives by providing financial compensation in the event a contract is exploited.

Participants in this protocol may be of three types. The two primary types are:
Stakeholders, which may be of two sub-types:
   Digital Asset Owners, who publish their digital asset code for inspection, and pay stakers a return on their stake and are the owner of the digital asset; and
   General Stakeholders, who are interested in the security of a digital asset and pay the stakers a return on a new stake; and
Stakers, who stake currency against the claim that a digital asset is flawed. A staker may be of two subtypes:
   Expert Staker, a staker who is on the TCR for this protocol; or
   Non-Expert Staker, a staker who is not on the TCR for this protocol.

Non-experts may be security experts who are new to this protocol or otherwise untrusted. Similarly, an expert staker may not be a security expert, but the use of a TCR greatly decreases this risk and increases the costs of impersonating an expert.

Stakeholders are not necessarily directly connected to, or working with, the contract owner, but may have an interest in the continued success of the contract. The operators of a service may wish to protect a contract's account balance, but users may also desire the continued existence of the service, and may wish to receive some funds to compensate for inconvenience caused by its failure (e.g., the cost of transferring to a new service). For a fully decentralized digital asset, a digital asset owner may not be clear, and users may wish to pay for the security of the service's up time in lieu of an owner guaranteeing its security.

The stakers need not contribute to a single pool; they may split their funds to multiple pools associated with multiple stakeholders. The stakers are free to choose the pools which pay the most in order to maximize their return. An individual staker can contribute any amount of funds to any pool.

Implicitly there is also a third actor, the Protocol Owner, who governs the smart contract in charge of managing payouts and accepting contract owners and stakes. The initial governance will be in the form of deploying the QSBb smart contract with fixed addresses that point to the TCR to be used and the QSP main network for automated audits. This actor may be a corporate entity or decentralized organizations. Such an actor may also be responsible for bootstrapping, e.g., populating the initial list of experts on the TCR.

Since some stakers are expected to be considered security experts, a method for their classification is important. A decentralized method for the classification of experts is the use of a Token Curated Registry (TCR). A TCR is a smart contract that keeps a short list of member addresses who are deemed to satisfy some property as determined by a voting community. Each TCR maintains a list of users who can be voted onto the list or voted off of the list by anyone with the token used to operate the TCR. A TCR using the QSP token can be deployed which tracks users as security experts.

TCR membership is desirable. When a stakeholder pays stakers, expert stakes are weighted more heavily than those of non-experts. This is to encourage the participation of experts and reward their time for manually inspecting an audit. Additionally, the stake of the first experts to stake are weighted even more heavily, as they are most likely to have actually performed an inspection, as opposed to experts who may simply follow other experts. If multiple experts stake the security of the same smart contract, each subsequent expert who stakes a value is weighted less than those experts who staked before them, but at least as much as a non-expert staking the same amount would be weighted. There may be multiple “first” expert stakers. All stakers who submit a stake in the same block are considered to be in the same position; therefore two expert stakers who submit at the same time may both become “first” stakers. This is to encourage the experts to spread their effort out to new contracts, which encourages the liveness of the system. As a side effect, it may also encourage the development of more rapid inspection techniques, but experts must take care to ensure the accuracy of these methods to avoid damaging their reputation and their removal from the TCR (in addition to the loss of any funds staked on insecure contracts). Conversely, non-experts are all paid without any bonus applied to the weight of their collateral.

In one embodiment, the protocol is initialized as follows:
1. The protocol owner establishes a TCR which will be used to classify expert stakers.
2. The protocol owner determines the address of an automated auditing platform that accepts a digital currency, say, Q.

After initialization, the protocol operates as follows:
1. A stakeholder h (it could be the case that h=owner in which case this is the owner, which is indicated by an owner field of the contract) submits
   1. the address C of a contract to QSPb;
   2. Integers eh(C)0 and fh(C)0, which are respectively the bonuses for expert stakes and first-expert stakes;
   3. a natural number ph(C)1 which is the payout period, in terms of blocks (a larger p will result in a longer delay before a payout after bad behavior);
   4. a natural number ch(C)=kh(C)ph(C) (where kh(C) is some natural number) which is the number of blocks that funds must be staked for;
   5. the maximum amount paid to stakers for each payout period mh(C);
   6. a minimum amount required to be staked lh(C);
   7. a staking timeout period th(C) (in terms of blocks);
   8. an initial deposit of kh(C)mh(C); and
   9. the requisite amount of QSP needed to audit the contract on the controlling network.
2. The digital asset C is sent to the controlling network, and a report is published. The report is not post-processed by any security expert; false positives may remain.
3. Until at least lh(C) is staked in a pool, the ith staker can stake V(Si) for contract C by sending (V(Si, h), h, C) where h indicates the stakeholder to which they wish to stake funds, to QSPb.
4. If, after the report for C is published, th(C) blocks pass without the pool collecting lh(C) funds, the pool is cancelled and the stakers may withdraw their funds.
5. Every p blocks after lh(C) is staked in the pool, provided that the protocol has not determined a breach of the contract C has taken place, stakers of a pool can claim their payout. In particular, for each pool h, each staker Si (for all i) is entitled to an additional

V(Si,h)[(1+eh(C))i\hat{ }[(1+fh(C))]]/Sum(P)×mh(C)
where (1+eh(C))i is applied to the numerator if the staker is the ith expert, fh(C) is also applied if the staker was the first expert to stake funds (i.e., i=1), and (P)=V(S1,h)(1+eh(C))(1+fh(C))+V(S2,h)(1+eh(C))2++V(S|E|,h)(1+eh(C))|E|+V(S|E|+1,h)++V(S|E|+|N|,h). The bonus factors (1+eh(C))i and (1+fh(C)) are applied if, at the time funds were staked, the address staking the funds is on the TCR. That is, if the expert is no longer deemed an expert, they are still treated as one for the purpose of this contract.
6. If at any point, the QSPb protocol deems C to have been breached (by query from the stakeholder), stakeholders can claim the staked funds and unassigned deposit funds.

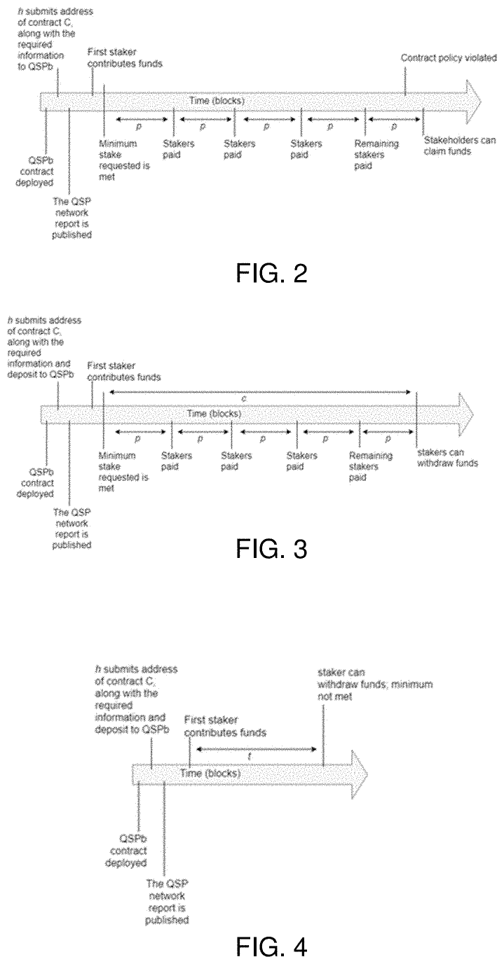

An example use of the protocol for some digital asset C is depicted in FIGS. 2-4. O is the owner; there is no differentiating experts and non-experts. FIG. 2 shows the protocol in the event that a staker backs out successfully, while FIG. 3 shows the protocol in the event that a staker attempts to back out too close to the attack. FIG. 4 shows the protocol in the event that a stakeholder wishes for more security. Additional stakers eventually arrive to provide the assurance required to the stakeholder.

There is no maximum amount of stakers, nor is there a maximum amount that can be staked for a given pool. Therefore, a staker may wish to stake more than the minimum requested by the stakeholder. This may encourage the stakeholder to increase their periodic payouts, but stakeholders are under no obligation to do this. One reason to enable arbitrarily large staking pools and an arbitrarily large set of stakers is to encourage the liveness of the protocol and enable non-experts to participate, which may increase the available security expertise. Even if an arbitrarily large amount of stakers have staked funds, a stakeholder never pays more than the amount they wish to, as each staker earns a fraction of this fee proportional to the amount of funds that they have staked.

An initial deposit is required from stakeholders. This is required in order to prevent a malicious party from posing as a stakeholder promising a large periodic payout. This may attract many stakers, resulting in the funding of this pool instead of others. A deposit ensures that these stakers are paid, so that these malicious parties do not scare away stakers. The size of the deposit is not set—it is up to the stakers to ensure they are comfortable with a small deposit—this may mean the pool is cancelled earlier than expected.

One implementation of the TCR and the QSPb protocol will operate using QSP tokens. QSPb will be implemented in one smart contract, which will handle the stakes and fees of all contracts submitted by stakeholders. The single smart contract enables the protocol to be released once, and exist in perpetuity without intervention from a controlling entity or others. It also means that users would not need to write their own pool contracts (though they may still write their own policy rules).

In one embodiment, the QSPb protocol has a web interface (operated by the protocol owner) tracking the amount staked and the current return rate for submitted contracts. Such a web interface may also provide a place to comment on automatically generated reports. Alternative implementations could move the burden of advertising this information to contract stakeholders, or decentralize this service in some other manner.

The gas used to update the TCR and any values associated with a submitted contract, are the responsibility of the appropriate party calling the functions on the QSPb protocol (or TCR) smart contract. For example, if a contract owner wishes to update their maximum payout amount per pay period, they are responsible for paying the gas to update the appropriate variable.

Precisely defining what constitutes misbehavior may be contract specific, and is a significant challenge. Initially, the goal will be to implement such a definition in a small script that can be enforced by the QSPb smart contract. Each pool may have its own rules defining misbehavior, and they will be public in order to ensure that stakers know the conditions of the pool. Race conditions are a concern when ordering of expert staking matters. For simplicity, the protocol will order experts who stake at the same block as being in the same position.

A contract owner may intentionally hide a back-door into a contract that is relatively hard to detect, offer to pay significant returns, and claim a self-inflicted breach shortly after being staked by a large value, therefore netting a significant return. This is mitigated in part by the requirement that contracts have “obvious” bugs reported, which may prevent some backdoors. This requirement is enforced by the requirement that an automated report be published for the contract. This attack is closely related to “classic insurance fraud”. However, it is less of a concern because the data is publicly available from the beginning, and is immutable. Ultimately, it is the responsibility of the stakers to avoid staking funds on contracts that are not secure.

One way to mitigate this concern is to have a maximum pool size for each pool. A maximum staking pool size may be desirable, but a limit that an individual can stake is not. This is because such a limit would discourage experts from staking large amounts: if they wish to stake more than any one staker can stake, they will need to split their stakes across multiple source addresses, or identities. It is not likely the case that all these identities will belong to the TCR, and therefore they will not receive the expert (or the first-expert) bonuses. For non-expert stakers, this is not a concern.

If a contract is submitted alongside a rule which indicates misbehavior is something other than a theft of funds, creating a maximum pool size may be difficult to justify. In the event that a rule indicates misbehavior is financial loss, it is reasonable to set the limit to the maximum funds held by the contract in question; this is not possible for other behavior.

A variable return rate may result in a malicious attacker staking a large amount of wealth in order to drive the rate down to near zero for the other stakers. In turn, this may force legitimate stakers to withdraw their funds. After doing this, the attacker may withdraw all staked value and exploit a breach in the contract, causing the owner to be attacked without receiving any staked values. The success of this attack is unlikely, as it requires the high-value target contract to be attacked only after the stakers have staked their funds on the contract (i.e., inspected the contract), and no other attackers to exploit the issue prior to the withdrawal of the stakers. Moreover, as the value of the collateral increases, it becomes more and more expensive for an attacker to “buy-out” the majority of the pool, and some stakers, like the first-mover expert, may still be rewarded with a high enough multiplier to maintain their stake. Another way to mitigate this concern is to limit the size of a pool, but this introduces concerns discussed in the previous point.

This is mitigated in part by the prevention of new members joining an active pool, as it means this must be done all at once, reducing the possible number of other stakers aside from the malicious actors who want to stake.

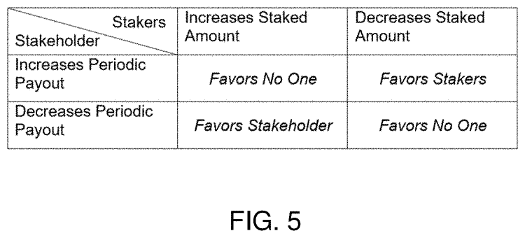

The QSPb smart contract must be seen as secure. One way to do this is to publish a report of a white-glove audit of the contract. A minimum required staked value is necessary to ensure stability. FIG. 5 outlines the payout matrix of this protocol without a minimum required staking amount. Stakeholders are never incentivized to increase their periodic payouts if they are not guaranteed any security; in fact, they always prefer to pay as little as possible. Stakers are not collectively incentivized to stake large amounts given a particular payout without the periodic payout being a function of their staked value; that would yield inadequate protection for stakeholders or, increase risk without any added value to the stakers.

The following illustrates the first case. Suppose that a stakeholder promises to pay 10 units of digital currency every period regardless of the amount staked, two stakers could each stake 1 and receive 5 units each, every pay period (for which the attack is secure, ignoring expert and first-expert bonuses). In this way, the stakeholder is not getting the desired level of security even though they are paying. In turn, this might lead to the stakeholder reducing their payments, which may result in the stakers withdrawing (part of) their stakes. This process may repeat until the stakeholder is too inconvenienced and ceases to use the system.

An example of the second case is as follows. Suppose that a stakeholder promises to pay 10 units of digital currency every period regardless of the amount staked, two stakers could each stake 100 units and receive 5 units each every pay period (for which the attack is secure, ignoring expert and first-expert bonuses). However, each staker could alternatively have staked 50 units, and each would still have received the same amount (5 units) as a payout. Staking 50 units is less of a risk: in the case the contract is hacked, now each staker only loses 50 units instead of 100 units. Therefore, this situation is preferred. It may not be feasible for stakers to collude in order to enact this scenario—which is necessary, as otherwise the proportion of payouts to each individual staker would change—but in the event that this happens, the payouts would reduce to the degenerate case described above. Each individual staker would still be incentivized to stake more than their peers, in order to control as much of the staking pool as possible.

The disclosed protocol can be applied to specific use cases where stakeholders may be particularly interested in getting a return in the event of misbehavior. For example, a relayer on the 0xProtocol [12] operates a node that hosts an off-chain order book. In order for this order book to be relevant, the 0xProtocol must be adapted by decentralized applications. The relayer may wish to pay for an increase in confidence that the contracts are secured, so that their relay node continues to be valuable.

A more interesting case is the integration of staking into a Decentralized Autonomous Initial Coin Offering (DAICO). In this version of an initial coin offering, token holders can vote on resolutions. However, project stakeholders may have a particular vision in mind for the project, and may wish to acquire economic security that token holders will fulfil this vision. The DAICO contract can be submitted to a generalized version of this protocol with the constraint that an “attack” is the unfavorable resolution of a particular vote, i.e., a hijacking of the direction of the project by its token holders, and a waste of the project developers' time and resources, and a betrayal of any potential investors' funds. A payout of this protocol can be used to e.g., pay back the investors in the event that the community is unfaithful.

There are several ways in which this protocol can be generalized or improved. There are minor improvements. A stakeholder may wish to provide several pay rates corresponding to different lengths of stakes, which would result in longer stakes earning a larger return. It may be possible to allow stakers to withdraw stakes subject to some conditions, or to allow stakeholders to vary payout rate dynamically while funds are staked.

The protocol need not target smart contract balances exclusively. It can be generalized to allow people to stake the security of arbitrary data that is accessible on the underlying blockchain. In this sense, stakers may be able to underwrite almost anything. In this sense, the protocol describes a decentralized full insurance model without explicit actuarial risk models.

A “bug-bounty” period can be implemented after smart contract submission but before stakers are able to submit their stakes. Such a period may increase the confidence of the stakers that they are staking funds on a secure contract.

The QSPb protocol contract could be updated to accept multiple staking currencies, so that stakers have the choice of staking whichever currency they are most comfortable using. In the event that stakers wish to stake a currency that differs from the stakeholder's periodic payment currency, there may be challenges to ensure that currency conversion is accurate, and payment is fair.

A contract may ultimately be published without any stakers staking its security. In the event that this system is widely adopted, this may mean that this contract is untrustworthy, or it may mean that the payouts should be increased in order to meet the market demand Other incentives may prove more useful or effective at increasing the liveness of the protocol, and these should be investigated.

Transitioning away from a centralized protocol owner may be desirable, and should be considered alongside other governance concerns. A fully decentralized implementation may wish to separate itself from a company network or use a different currency.

Staking pools may be enhanced so that contract owners can specify a whitelist of stakeholders to split their pot with. These stakeholders could be those who the contract owner has determined has a valid interest in the contract security without a need to compete for premium prices, just as the owner in the original scenario.

An additional layer of “re-insurance” could be implemented on top of this framework. However, care is required to ensure that this does not result in the unintentional loss of funds. In this case, an “expert of experts” actor may be crucial and introduce new technical challenges.

Some protocol owners may require at least one expert to be staked before non-experts can stake an arbitrary contract. Feedback from users or monitoring the system will determine if this is the case for the disclosed implementation. However, this raises additional questions: What happens if an expert is elected, stakes a contract, and is removed from this list: does their stake get returned to them, are other (non-expert) stakes invalid? The answer may also depend on whether the expert voluntarily removed themselves from the TCR or if they were voted off.

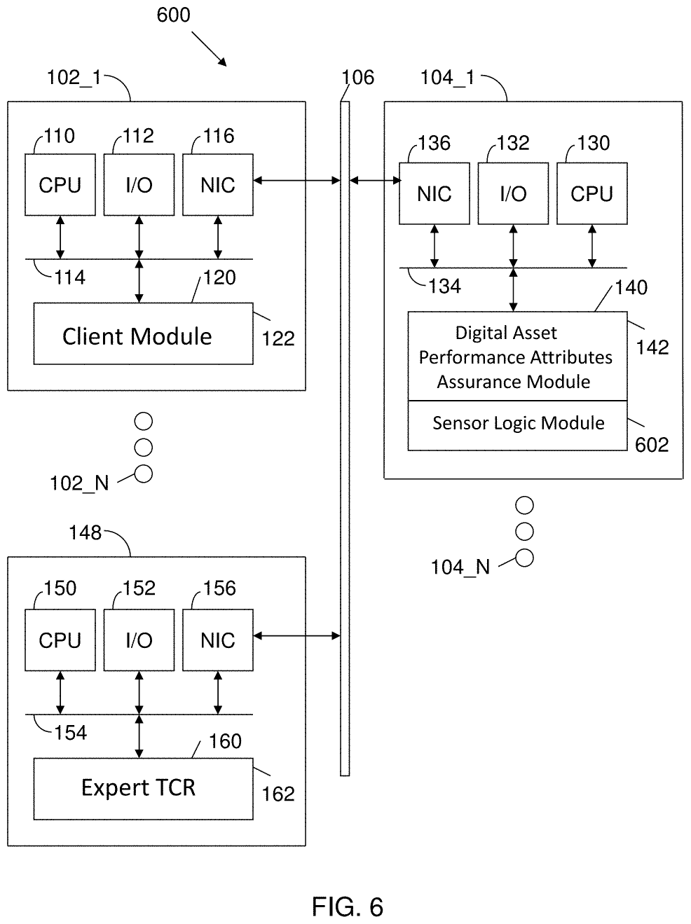

FIG. 6 illustrates a system 600 configured in accordance with an embodiment of the invention. The system 600 corresponds to the system 100 of FIG. 1, but server 104_1 includes a sensor logic module 602 in memory 140. The sensor logic module 602 implements operations disclosed herein. The sensor logic module 602 processes signals from sensor machines connected to network 106 (e.g., any of machines 102_1 through 102_N may be configured as sensor machines). The sensor machines connected to network 106 may be characterized as on-chain sensors (i.e., machines associated with a distributed ledger), off-chain sensors (i.e., machines unassociated with a distributed ledger), pattern-matching sensors (i.e., machines configured to identify specified signal patterns) and interactive sensors (i.e., machines in two-way communications with the sensor logic module 600).

The “Sensing Element” is the sensor's interface with the environment and it does not contain any decision logic, the only processing it does is possibly converting analog information into digital information such that it can be used as an input to the sensor logic module 602, which is an on-chain component of the sensor. The sensor logic module 602 takes the input information provided by the sensing element and performs some computation on this data, which will report on the data observed from the environment. The output of the sensor logic module 602 can be read and processed by any smart contract on the blockchain. In one embodiment of the sensor, the results may be as simple as a Boolean or integer value and as complex as a set of measurements compiled into a report and exportable for other use.

The sensor machines connected to network 106 reduce network bandwidth by only reporting certain bit patterns that represent a small fraction of data processed throughout network 600. Accordingly, the sensor logic module 602 operates on a fraction of network activity, which improves the functioning of server 104_1, while simultaneously improving network security efficiency.

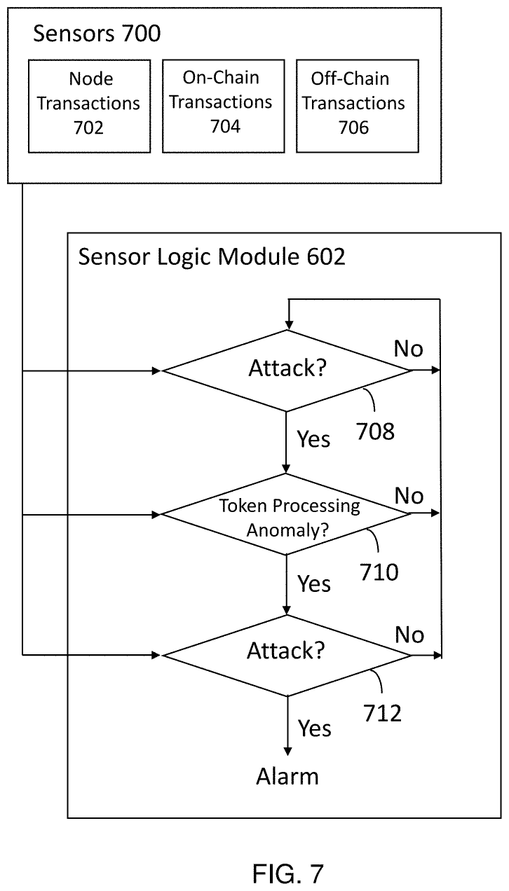

FIG. 7 illustrates sensors 700, including a sensor for node transactions 702, a sensor for on-chain transaction 704 and a sensor for off-chain transaction 706. Signals from each sensor are supplied to the sensor logic module 602. Sensor logic module 602 loops through conditions 708, 710 and 712. Condition 708 discriminates sensor signal patterns indicative of a smart contract attack.

The sensor inspects the patterns to look for signature bit patterns which may result in an attack path for the system for which module 142 collected consideration. The bit patterns are configured by the security assurance module 142, which specifies patterns that indicate an attack path. The severity ratings of the patterns are computed as a function of the expert consideration collected and stored by module 142. Those with greater consideration are prioritized, for example. Another instance of module 162, a Token Curated Registry, could be used to allow experts to assign weights to the vulnerabilities.

Thus, the sensors 700 evaluate defined criteria to periodically communicate to the sensor logic module 602 suspicious bit patterns. The suspicious bit patterns are evaluated by the sensor logic module 602 to periodically issue a warning when the suspicious bit patterns exceed a threshold associated with the expert digital consideration. Thus, the sensor logic module 602 efficiently processes a small subset of network activity to identify security problems in the context of staked expert digital consideration. This architecture reduces network bandwidth, improves the function of the machine executing the sensor logic module and enhances network security efficiency.

If such an attack path is present (708—Yes), it is determined whether there is a token processing anomaly. An attack path may exploit different vulnerabilities, and the vulnerabilities are prioritized by the stakeholder propositions provided to the system 142. Priorities for the vulnerabilities may have been computed using current leading approaches or proprietary systems of the experts connected to module 142.

If there is vulnerability which has been prioritized by expert stakeholders and the likelihood of its success is deemed to be sufficiently high (710—Yes), additional conditions are evaluated to determine the presence of a smart contract attack. The bit patterns identified by the sensing element can be inspected to see if the control flow of the system included predefined security measures (such as halting the system) which were bypassed or if the transaction metadata encoded targets specific accounts or values. The bit pattern identified may encode a control flow graph (CFG) which can be parsed in order to determine if previously unreachable problematic parts of the system are now accessible.

If such an attack exists (712—Yes), an alarm is sent, for example, to client machine 102_1. The attack assessment may vary from instance to instance, while the common feature is evidence of token minting, depositing, burning, or withdrawals.

An on-chain sensor is configured to detect smart contract state/variable changes over the course of a contract's lifetime. The sensor is composed of a software system connected to the blockchain. The sensor polls the contract state value at particular intervals, or when it is relevant/necessary. For example, a sensor returns true if the contract at a given address has a balance of zero at the time when the sensor is read. The sensor may compare values in the system register to check if the destination of a transaction is different from an intended destination, for example. A sensor may be configured to return true if the contract at a given address has an owner that is the same as when the contract was initialized. A sensor may be configured to govern the minting of tokens (e.g., ERC20 tokens). The sensor returns true if the number of coins minted is higher than a specified maximum (which is indicated when the sensor is instantiated) at the time the sensor is read. A sensor may poll for data in several smart contracts, either simultaneously or sequentially, and return a result based on a function of the values observed.

An off-chain sensor is a sensor connected to the system which is not a smart contract. Off-chain sensors may be implemented by traditional IT systems, e.g. meteorological service or a classical banking system, and may include physical components. Such a sensor is connected to the blockchain system/smart contract, which is configured to query the off-chain sensor at any time.

An interface with the entity being monitored/sensed may be implemented with a connection to the blockchain. This interface may be composed entirely of software (e.g., when the sensor is monitoring a bank account via a bank's API), or have hardware components (e.g., when a sensor detects the weather). Such a sensor may be configured to read the value used by an exchange or bank database indicating the current market value of a token or asset in, for example U.S. Dollars, as determined by supply and demand Alternately, a sensor may observe the real-world for measurable changes, for example the opening of a door or the temperature of a location.

A pattern matching sensor may be on-chain or off-chain, but also includes functionality to use sequences/sets of data items such as transactions and look for predefined patterns or anomalies in typical patterns in order to detect performance and security issues. Embodiments of the previous categories of sensors (i.e., on-chain and off-chain sensors) may not capture all state changes. This category of sensor may include off-chain components to parse and interpret the transactions of the blockchain, watching for those transactions which are interacting with the target contract.

The sensor logic module 602 may be configured as a trained machine learning model. In this embodiment, the sensor logic module 602 reads a specified set of accounts and observes if these accounts have similar behavior patterns (e.g., several accounts deposit or withdraw with the same on-chain systems or using similar amounts). Such an embodiment may be used, for example, to attempt to associate data which is not immediately connected on-chain or capture user intent.

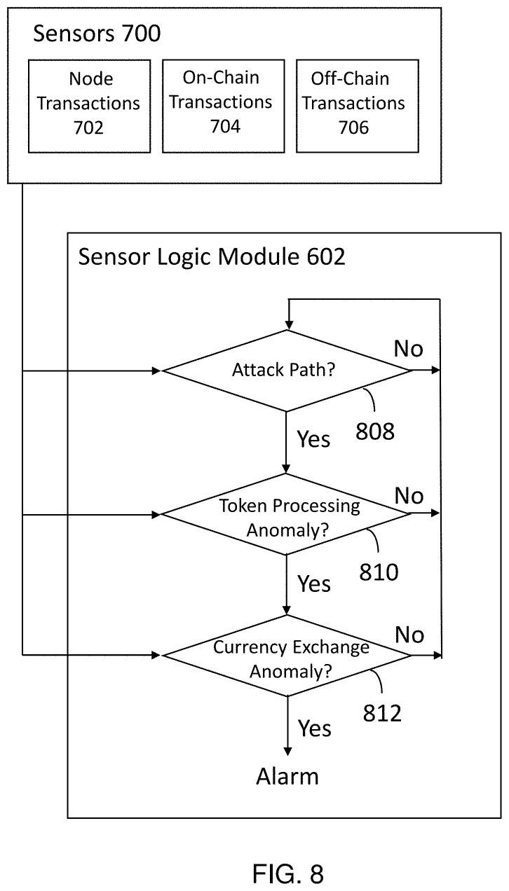

The decision flow of one such embodiment is shown in FIG. 8. This embodiment could be used to detect attacks that deplete a pool of assets over time, which may not be detectable via other sensor types. The embodiment takes as input the transaction history from a blockchain node. The embodiment contains a decision module or logic module, which performs several checks sequentially. The conditions can be encoded as Boolean values, which all have to be TRUE in order for the Decision Module to output a positive value that could trigger an alarm. Otherwise, the output will be negative, and no alarm is triggered. First, it is determined if there is a possible attack path 808, such as whether there has been a sufficiently large number of repeated transactions, e.g., 10, from a particular address to another, within a window of 100 blocks, which enables a theft of funds. The likelihood of success is calculated based on the density of these calls within the last 100 blocks. Next, it is determined whether there is a token processing anomaly 810, such as function calls that are repeatedly called mint and burn (i.e., create and destroy) any on-chain assets. Because the tokens may call arbitrary functions on other smart contracts, a control flow graph of the systems called can be parsed and evaluated. Comparing this graph against the potential threats to the examples provided by the experts who interact with the security assurance module 142, the sensor can perform statistical analysis, or use satisfiability analysis to determine if the attack path is feasible. For example, the minting of the maximum number of tokens allowed by the system would be an anomalous activity which would be reported.

Finally, it is determined if there is a currency exchange anomaly 812, such as a non-zero amount of on-chain assets, which are exchanged for another on-chain asset subsequently in the same block transaction window. In such a case, it reports that an attack has occurred, and otherwise it resets its internal state. A sensor can also use the analysis performed in its logic module to report on the effectiveness of security practices that the attack would have bypassed in some scenarios.

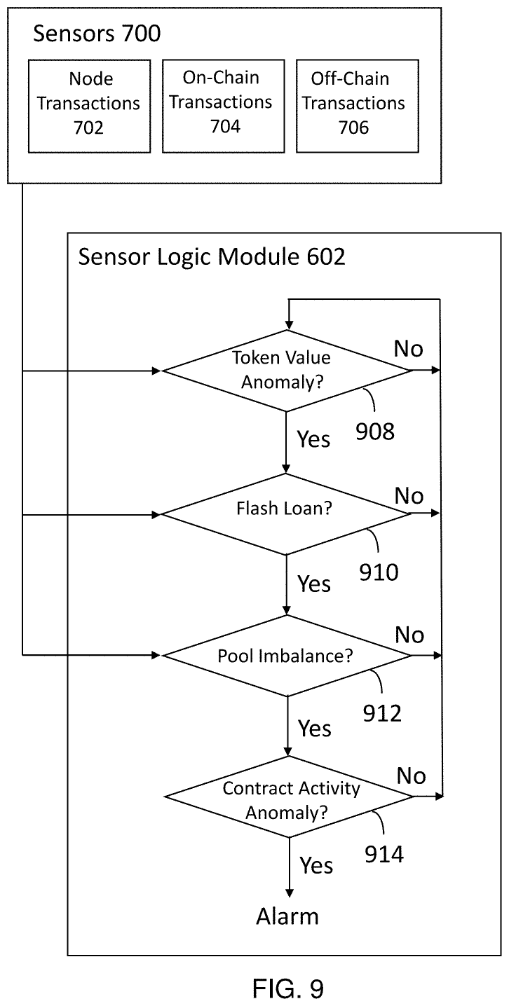

FIG. 9 illustrates a rule-based sensor logic module 602. This module may watch a set of transactions to see if a particular account performs some pattern that can be specified in a formal rule in a specific time frame/window. In one embodiment, the module watches to see if an account sends assets to more than a specified number of other accounts. This embodiment could be used to detect attacks that use flash loans on-chain.

The embodiment takes as input the transaction history from a blockchain node, off-chain price oracles, and the price history of a particular on-chain asset. The embodiment contains a decision module or logic module, which performs several checks sequentially. The conditions can be encoded as Boolean values, which all have to be TRUE in order for the module to output a positive value that could trigger an alarm. Otherwise, the output will be negative and no alarm is triggered. First, the module identifies a token value anomaly 908, such as if the current price of the asset is significantly different from historical averages. In this embodiment, it checks if the asset is significantly undervalued. If there is no significant difference, this module will not expect an attack and resets its internal state. If there is a significant difference (908—Yes), the module will also consider the transaction history of the blockchain node. Parsing this history, the node can determine if there is a particular type of possibly malicious transaction, called a flash loan in the most recent history, e.g., the last ten blocks 910. A flash loan may change the balance of an on-chain collection of an asset, called a pool, which may include other assets. In particular, a pool may contain a pair of assets, so that users may supply one asset into the pool in exchange for the other at a fair price. If the flash loan changes the supply of an asset in this pool significantly (910—Yes), a pool imbalance is assessed 912. That is, the module determines if a particular on-chain smart contract, which interacts with the given pool, may have lost funds as a result of the previous transaction. In such a case, it reports that an attack has occurred, and otherwise it resets its internal state.

An embodiment of the present invention relates to a computer storage product with a computer readable storage medium having computer code thereon for performing various computer-implemented operations. The media and computer code may be those specially designed and constructed for the purposes of the present invention, or they may be of the kind well known and available to those having skill in the computer software arts. Examples of computer-readable media include, but are not limited to: magnetic media such as hard disks, floppy disks, and magnetic tape; optical media such as CD-ROMs, DVDs and holographic devices; magneto-optical media; and hardware devices that are specially configured to store and execute program code, such as application-specific integrated circuits (“ASICs”), programmable logic devices (“PLDs”) and ROM and RAM devices. Examples of computer code include machine code, such as produced by a compiler, and files containing higher-level code that are executed by a computer using an interpreter. For example, an embodiment of the invention may be implemented using JAVA®, C++, or other object-oriented programming language and development tools. Another embodiment of the invention may be implemented in hardwired circuitry in place of, or in combination with, machine-executable software instructions.

The foregoing description, for purposes of explanation, used specific nomenclature to provide a thorough understanding of the invention. However, it will be apparent to one skilled in the art that specific details are not required in order to practice the invention. Thus, the foregoing descriptions of specific embodiments of the invention are presented for purposes of illustration and description. They are not intended to be exhaustive or to limit the invention to the precise forms disclosed; obviously, many modifications and variations are possible in view of the above teachings. The embodiments were chosen and described in order to best explain the principles of the invention and its practical applications, they thereby enable others skilled in the art to best utilize the invention and various embodiments with various modifications as are suited to the particular use contemplated. It is intended that the following claims and their equivalents define the scope of the invention.

1. A computer implemented method, comprising:
maintaining at a first network connected server a record of a group of stakeholders with an interest in the performance attributes of a digital asset, wherein maintaining includes collecting stakeholder digital consideration from the group of stakeholders;
storing at a second network connected server a list of experts on the performance attributes of digital assets;
receiving from a network connected expert client machine a first endorsement of the performance attributes of a digital asset and expert digital consideration, wherein the first endorsement is received at the first network connected server;
receiving from a network connected non-expert client machine a second endorsement of the performance attributes of the digital asset and non-expert digital consideration, wherein the second endorsement is received at the first network connected server;
periodically distributing by the first network connected server stakeholder digital consideration increments of the stakeholder digital consideration to the network connected expert client machine and the network connected non-expert client machine; and
automatically distributing to the stakeholders the expert digital consideration and the non-expert digital consideration in the event that the first endorsement and the second endorsement of the performance attributes of the digital asset do not match defined criteria, wherein automatically distributing is initiated by the first network connected server utilizing the network to distribute to network connected stakeholder client machines, and wherein the defined criteria is collected from network connected sensor machines periodically communicating to the first network connected server suspicious bit patterns that are evaluated by the first network connected server to periodically issue a warning when the suspicious bit patterns exceed a threshold associated with the expert digital consideration.

2. The method of claim 1 wherein the digital asset is a computerized transaction structure that executes the terms of a contract.

3. The method of claim 1 wherein the digital consideration is digital currency.

4. The method of claim 1 wherein the digital consideration is a digital resource grant.

5. The method of claim 1 wherein the performance attributes include security vulnerabilities.
